(19) United States
(12) Patent Application Publication
(10) Pub. No.: US 2004/0201621 A1
(43) Pub. Date: Oct. 14, 2004

(54) Presentation program and method

(76) Inventor: Bruce W. Stevens, North Kingstown, RI (US)

Correspondence Address: Office Of Counsel, Bldg 112T, Naval Undersea Warfare Center, Division, Newport, 1176 Howell Street, Newport, RI, 02841-1708, US

(21) Appl. No.: 09/977,900

(22) Filed: Oct. 10, 2001

(51) Int. Cl. G09G 5/00

(52) U.S. Cl. 345/751; 715/526

(57) ABSTRACT

There is provided a computer software program and method for simultaneously playing a programmed sequence of graphics and sound files on each of a plurality of computers which may or may not be networked together, which may or may not be similar computers with similar clock times and processing speeds, and which does not require any hardware changes to any of the plurality of computers. Each computer may control a plurality of different monitors and the present invention permits different presentation displays (e.g., graphics) to be displayed on each of the computer monitors controlled by a particular computer. The present invention provides that a plurality of simultaneously running software control programs simultaneously supports, times, retrieves, and plays files for of the plurality of computer programs to thereby utilize the plurality of computers to produce a synchronized presentation.

### STATEMENT OF THE GOVERNMENT INTEREST

The invention described herein may be manufactured and used by or for the Government of the United States of America for Governmental purposes without the payment of any royalties thereon or therefore.

### CROSS-REFERENCE TO OTHER PATENT APPLICATIONS

Not applicable.

### BACKGROUND OF THE INVENTION

(1) Field of the Invention

The present invention relates generally to computer presentation applications and, more specifically, to a computer program that may be utilized for a presentation which utilizes multiple computers and multiple associated displays.

(2) Description of the Prior Art

A weapons control system environment forms a computer complex that may utilize numerous different workstations with each workstation having one or more computer screens. In the prior art, an actual use or complex simulation is necessary to demonstrate operation of the weapons control system. Prior art software applications do not provide for a coordinated presentation wherein multiple computers display different images and/or sounds. Special hardwire modifications have been utilized in the past as discussed subsequently in the listed prior art patents for producing multiple displays, but hardwire modifications are often undesirable.

Prior art computer programs presently exist that may be utilized to produce a series of images on a computer screen to thereby provide a slideshow presentation. However, the prior art programs may not be utilized to control a presentation that utilizes simultaneously running multiple computers in a computer complex with each computer displaying different graphics and wherein each of the plurality of computers within the computer complex may have one or more screens, which may also show different images at different times.

Prior art computer programs for slideshow presentations may encounter other problems such as the computers in a computer system may be quite dissimilar and have different operating systems whereby a prior art computer presentation program will not even run on all the different computers. The prior art also does not provide software means for controlling timing of the presentation by coordinating each computer display with the display of other computers. While the prior art does provide for slide show presentations or video presentations, prior art programs do not provide a software means for simultaneously starting and operating all computers in a computer system whereby each computer may display different images. While images can be sent over a networked system, there is a time lag in transmission in a networked system due to the volume of data in each image. Combat video simulations may require thousands of images to be displayed within a short time period and cause a data flow volume that would tend to drag performance of a presentation down.

Patents that show attempts to solve the above and other related problems are as follows:

U.S. Pat. No. 5,488,385, issued Jan. 30, 1996, to Singhal et al., discloses that video information is simultaneously generated for presentation on multiple displays by a display system including a video memory having a plurality of addressable storage locations, each storage location providing for the storage of data representing a component of an independent displayable image and a video controller providing a plurality of output display control and data signals connectable to a respective plurality of video displays. The video controller accesses the video memory in a predetermined addressing pattern so as to access a sequence of the components corresponding to a plurality of the independent displayable images. The video controller, in turn, generates the plurality of output display control and data signals whereby the sequence of the components provided by way of each of the plurality of the output display control and data signals corresponds to a respective one of the independent displayable images.

U.S. Pat. No. 5,606,336, issued Feb. 25, 1997, to Yuki discloses that a display control apparatus permits display by a single display control apparatus on a plurality of display devices which receive image data by an internal synchronization signal. The display control apparatus outputs input image data to a plurality of display devices and includes a control circuit for selecting the longest one of the internal synchronization signals from the display devices and a unit for supplying the image data to the display devices in synchronism with the selected synchronization signal.

U.S. Pat. No. 5,959,686, issued Sep. 28, 1999, to Jeong discloses an apparatus and a method for controlling a plurality of sub monitors in a video communication system in which the same signal from a host computer or a video tape recording/reproducing device is displayed on screens of the sub monitors and a main monitor to which the sub monitors are connected in series. The main monitor generates control data in response to an external sub monitor control signal to set up a desired one of the sub monitors. A plurality of communication devices are included respectively in the sub monitors, for serially transferring the control data from the main monitor to the sub monitors and response data from the sub monitors to the main monitor. A plurality of microcomputers are connected respectively to the communication devices, for setting up a corresponding one of the sub monitors in response to the control data from the main monitor when the control data from the main monitor is for the control of the corresponding sub monitor and transferring the control data from the main monitor to the subsequent sub monitor when the control data from the main monitor is not for the control of the corresponding sub monitor. According to the present invention, the main monitor can control the plurality of sub monitors using the communication devices therein and a program for the control thereof.

U.S. Pat. No. 5,969,696, issued Oct. 19, 1999, to Stoye discloses an invention providing an interface for a computer system that can drive several different display systems. The interface of the invention consists of power signals, ground signals, sense signals, programmable signals, and a few miscellaneous signals. The sense signals are driven by each display system that is designed to operate with the invention's interface. Each display system drives the sense signals with a code that uniquely identifies the display system. The interface is self-configuring such that the computer system reads the unique code output on the sense signals and correspondingly outputs the proper display information on the programmable signals to drive the display system connected to the interface.

U.S. Pat. No. 6,046,709, issued Apr. 4, 2000, to Shelton et al., discloses a method of synchronizing, at a system frame display rate, a first set of frames displayed by a first monitor with a second set of frames by a second monitor, utilizes frame production rates of the two sets of frames to set the system frame display rate. More particularly, the first set of frames are produced at a first frame production rate by a first graphics engine, and the second set of frames are produced at a second frame production rate by a second graphics engine. The first frame production rate and second frame production rate first are compared to determine which frame production rate is slower. The system frame display rate then is set to be no greater than the slower of the two frame production rates.

U.S. Pat. No. 6,104,414, issued Aug. 15, 2000, to Odryna et al., discloses a video distribution hub and display method which is capable of driving a plurality of video display monitors as a virtual monitor or monitors. The video distribution hub receives a video signal from a single head graphics card or a suitable video source which signal embodies data within a video buffer on the graphics card or at the video source. The hub processes the received video signal and stores selected data segments corresponding to selected portions of the video buffer in a plurality of frame buffers within the distribution hub. The data stored within the plurality of frame buffers is employed to drive respective video displays, such as flat panel displays or conventional CRT displays. The hub accommodates displays of different resolution. Additionally, the hub accommodates displays having either a portrait or landscape orientation.

The above cited prior art which does not show a suitable purely software means for synchronizing the display of time sequenced series of images amongst any number of various like and dislike computers without the need for hardware changes to the computers or computer system. Consequently, those skilled in the art will appreciate the present invention that addresses the above and other problems.

### SUMMARY OF THE INVENTION

It is an object of the present invention to provide an improved presentation system for controlling multiple computer station presentations.

It is another object of the present invention to provide such an improved presentation which further individually controls unlike or different multiple computer presentations displayed on different monitors of a multiple monitor computer station.

It is still another object of the present invention to provide a program that will operate on different computer operating systems.

It is yet another object of the present invention to time synchronize a plurality of computers in a computer system.

These and other objects, features, and advantages of the present invention will become apparent from the drawings, the descriptions given herein, and the appended claims. It will be understood that above listed objects and advantages of the invention are intended only as an aid in understanding aspects of the invention, are not intended to limit the invention in any way, and do not form a comprehensive list of objects, features, and advantages.

Accordingly, the present invention provides a method for making (or generating) a presentation on a plurality of computers or computer stations utilizing a software control program. The method may comprise one or more steps such as, for instance, providing that the software control program is written in a platform independent computer programming language, installing at least one instance of the software control computer program on each of the plurality of computers, running the software control program simultaneously on the plurality of programs, and automatically starting unlike or different sequences of displays for each of the plurality of computers utilizing the simultaneously running software control programs. Other steps may include providing that the sequence of displays differs between the plurality of computers and/or installing a respective set of files to be played by each of the plurality of computers for the presentation including an initial file to be played and an ending file to be played and/or timing playing of each the files of the respective set of files for each of the plurality of computers such that a beginning time and play duration time is effectively associated with each file.

The step of automatically starting may further comprise providing an initial file start time for each instance of the software control program on each of the plurality of computers.

Thus, a method for making a presentation comprising steps such as, for instance, installing for single execution of the software computer control program on a one of a plurality of computers, or alternatively for simultaneous and independent (“in parallel”) execution of the software program on a one of a plurality of computers, installing a respective set of files to be played by each of the plurality of computers for the presentation including an initial file to be played and an ending file to be played, associating timing for playing of each the files of the respective set of files for each of the plurality of computers whereby an effective beginning time and play duration time is associated with each file, providing a start time for an initial file to be played on each of the plurality of computers, providing that each computer is synchronized to a common time, providing that each instance of execution of the control program on each of the plurality of computers displays the initial file at the respective start time, and sequentially playing each file in each respective set of files for each of the plurality of computers.

The respective set of files for each of the plurality of computers may include graphic files and/or audio files to be played. The method may comprise instances of simultaneous and independent executions of the software control program on a computer associated with a plurality of monitors where each instance of execution of the software control program independently coordinates a presentation display sequence for a respective one of the plurality of monitors operated by the computer. The effective beginning time and play duration time may be determined from an absolute beginning time and an absolute ending time or the effective beginning time and play duration time may be determined based on a collective time of previous image files and a given play duration time.

Thus, the invention provides a software control program is operable for running simultaneously on a plurality of computers and may include software elements such, for instance, a read scenario command to read the scenario file which lists the files to be played and associated timing thereof, at least one get image command to retrieve each image file listed in the scenario file, and a software timing control operable for coordinating timing of display of each image file for each of the plurality of computers to provide a coordinated presentation utilizing the plurality of computers. The software control program may be written in a platform independent computer programming language so as to be operable on computers which may have dissimilar or different operating systems. The invention may further comprise a display command to designate a particular display for a multiple display computer associated with a plurality of displays. For instance, the command may set an x, y raster position of a composite multiple display raster area for each unlike presentation display of a plurality of unlike presentation displays on a desired monitor of the multiple display computer station. An additional feature useful in the present invention is a time control program for setting an internal clock of all of the plurality of computers to a common time.

### BRIEF DESCRIPTION OF THE DRAWING

A more complete understanding of the invention and many of the attendant advantages thereto will be readily appreciated as the same becomes better understood by reference to the following detailed description when considered in conjunction with the accompanying drawings wherein corresponding reference characters indicate corresponding parts and wherein:

FIG. 1 is a block diagram of a JAVA control program in accord with the present invention;

FIG. 2 is a block diagram of a computer complex, including networked and stand alone computer stations with displays/speakers that may be utilized for a synchronized presentation by means of the JAVA control program of FIG. 1; and

FIG. 3 is a diagrammatic representing the mapping of a plurality of displays or monitors to a composite raster area.

### DESCRIPTION OF PREFERRED EMBODIMENTS

The present invention provides the opportunity to make or generate unique and interesting graphics sound effects for presentations and the like which can make a complex computer system seem to come alive.

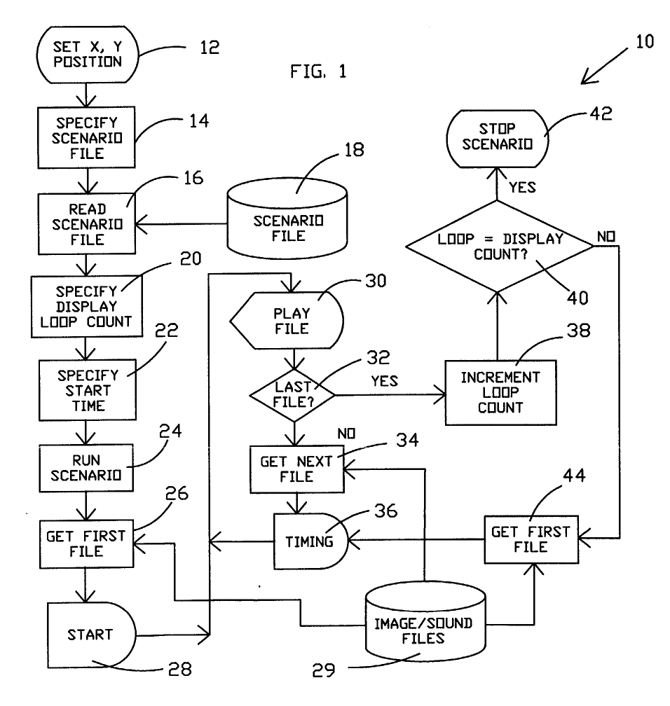

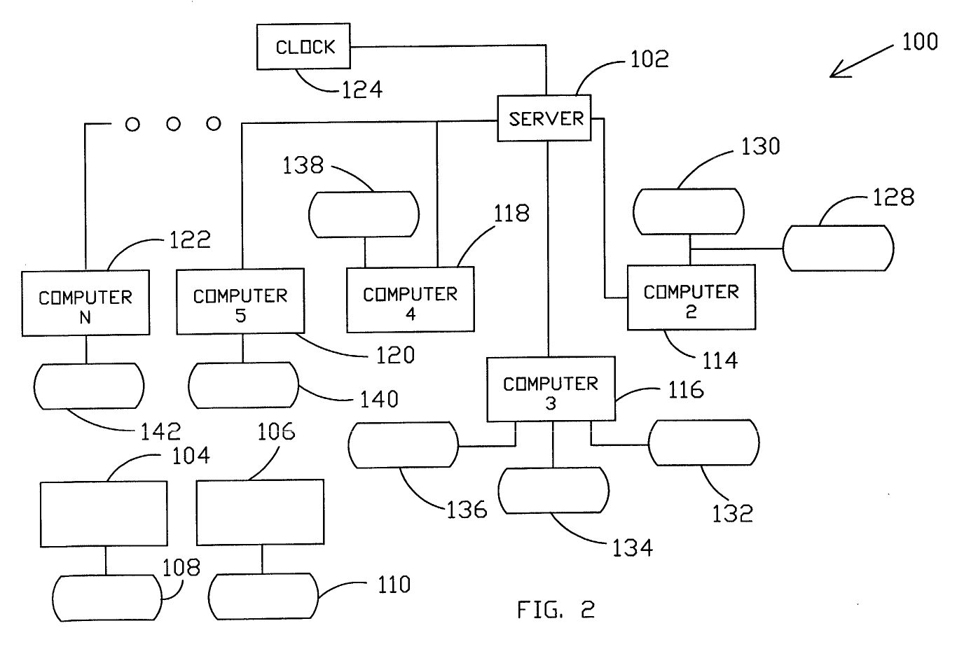

Referring now to the drawings, and more particularly, to FIG. 1 and FIG. 2 there is shown presentation program 10 which may be utilized for producing a presentation for display using multiple computer stations of computer complex 100. Presentation program 10 may be utilized for synchronizing a plurality of computers such as computer complex 100 which comprises N computers and which may comprise N or more computer displays and/or acoustic speakers. Computer complex 100 may typically include one or more networked computers stations connected to one or more servers 102. However, presentation program 10 may also be utilized to coordinate one or more free standing computer stations that have no interconnections such as computers 104 and 106 and associated displays 108 and 110, respectively.

In a preferred embodiment, a separate clock program 124 of a type well known in the prior art may preferably be utilized to set each internal clock of each computer, such as computers 1-N, designated as 114, 116, 118, 120, and 122, to the same time. Typically, clock programs 124 are in contact with a national time standard and are extremely accurate. Numerous displays or monitors are operatively associated with the computers. In many cases one computer will have multiple display monitors, and the computer will control the running or displaying of unlike presentations on different monitors. Thus computer 114 controls displays 128 and 130, computer 116 controls displays 132, 134, and 136, computer 118 controls display 138, computer 120 controls display 140, and computer 122 controls display 142. Presentation program 10 may be used to coordinate a presentation on any number N displays with the display presentations unlike or different, for the any number N computers, and utilizing tens of thousands of graphics/sound files. Note that it is assumed that each display may also have an attached sound speaker and/or separate speaker so that sounds can also be produced, e.g., an alarm or the like for presentations simulating a combat control system.

In a presently preferred embodiment of the invention, presentation program 10 is written in a platform-independent language so that presentation program 10 may be developed and executed on a number of dislike computers executing dislike operating systems. It is also desirable that computer program 10 present the operator with a uniform graphical user interface across the various computers. While a presently preferred embodiment of the program is written in the Java programming language to thereby fulfill the above desirable characteristics, computer program 10 could also be written in other computer languages.

Due to the fact that computer program 10 operates computers having multiple displays, in a presently preferred embodiment when computer program 10 is started, a desired x position and y position of the upper left hand corner of a particular display, relative to the x, y coordinates of a composite raster area of all the displays, is preferably specified as indicated at 12. A plurality of separate copies of a single computer program such as program 10 can be simultaneously executed on a single computer system. Each executing “copy” of a program corresponding to a display executes independently in its own address space. This allows multiple instances of computer program 10 to be executed on a single computer supporting multiple displays such as computer 116 which supports computer monitors or displays 132, 134, and 136.

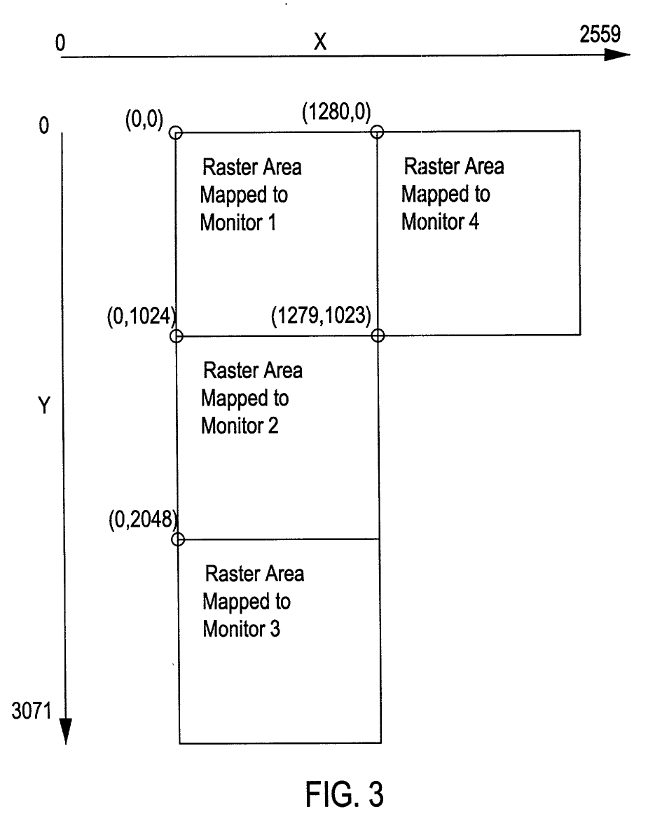

It is well known that a plurality of display monitors connected to a single computer system can map each individual display monitor to a separate, non-overlapping rectangular section of said computer's raster display area. For example, four separate monitors can be arbitrarily mapped to four separate, non-overlapping, rectangular sections as shown in FIG. 3. Each rectangular area in this example is 1280 pixels wide by 1024 pixels high. Monitor 1 is mapped to the raster area representing by the upper left hand coordinates located at x=0 and y=0. Monitor 2 is mapped to the raster area represented by the upper left hand coordinates located at x=0 and y=1024. Monitor 3 is mapped to the raster area represented by the upper left hand coordinates located at x=0 and y=2048. Monitor 4 is mapped to the raster area represented by the upper left hand coordinates located at x=1280 and y=0. For example, assume there is a total composite image display area of x=1280 by y=1024, and the requirement is to match display area to the raster area mapping of FIG. 3. A separate simultaneous and independent “parallel” execution of program 10 can be mapped to a separate display monitor through specification of the appropriate upper left hand raster area coordinate as shown in FIG. 3. Expressed as a table:

| MONITOR | x, y, VALUES IN PROGRAM 10 |
|---|---|
| 1 | (0, 0) |
| 2 | (0, 1024) |
| 3 | (0, 2048) |
| 4 | (1280, 0) |

Note that as is well known, a pixel is a single addressable dot in the raster area that can be assigned a color.

Each instance of computer program 10 can therefore be directed to display different images with different timing, for instance, on each particular display 132, 134, and 136. That is to say unlike or different display presentations appear on the different computer monitors or displays. However, other means for designating or separately controlling multiple displays on a single program could also be utilized.

Computer program 10 may preferably provide a control window at step 14 which allows the user to specify a scenario file. The control window preferably has command menus and status displays for this purpose. The scenario file is preferably a simple text file, or other type of file, that specifies a list of image graphics files, and/or sound files, and an associated timing. The scenario file preferably specifies the location of the file in some suitable means such that computer program 10 can find the file, e.g., a complete file extension name, a beginning memory location, or the like.

In cases of a computer controlling a plurality of displays (or monitors) plurality of sets of files, each set for a respective display or monitor, is present in computer storage. The scenario file sets up timing and coordination of sequences for the playing of the individual file.

The timing may be of several types in accord with the present invention with the goal being to coordinate the displays of multiple computers whereby if time lag or delay occurs in one computer, the collective presentation process nonetheless corrects itself and remains on schedule. In one example, the time may be a relative time whereby the associated display time refers to the amount of time that an associated image/sound will remain displayed/played on the selected graphics screen before the next image/sound is activated. In another example, the time may be an absolute time, e.g., 9:00:00.000 A.M to 9:00:00.1, whereby the display is for one-tenth of a second that starts and ends at designated times. In another example, the time may be a collective time whereby each graphics/sound file is activated based on the end time of another file for a selected delay with respect to an absolute time. Sound and image files may be played simultaneously, when desired, i.e., the start and/or end times may be coincident.

Thus, in computer step 16, the computer program reads the scenario file 18 specified in step 14, and constructs a list of image graphic files/sound files and appropriate absolute, relative, or delay times. In step 20, the user has the option to specify a loop count that allows the complete list of files in the scenario file to be activated a desired number of times. The default is one and in effect, the presentation will be presented once if the default is used, twice if the count is set to two, and so forth.

At computer step 22, a start time is specified whereby the user specifies the exact time to play the first image/sound file. At step 22, the computer may then calculate the exact time to display succeeding images, such as for instance, by adding the delays associated with each image. If absolute times are utilized, then the timing is already available in the scenario file. The delay times and starting times may be used to calculate absolute times, if desired. Thus, the timing can be effected in different ways with the goal being to coordinate the overall presentation with, effectively a common clock, based on the accurate time clock in each computer.

At step 24, program 10 runs the scenario when the start time occurs. In one embodiment, after step 22, program 10 may first blank the screen, display the time the first file will be played, loads the first graphics and/or sound file to play into computer memory as indicated at 26 and waits until the start time, specified in step 20, arrives. In this way, each computer screen can be fetched into computer memory prior to the beginning the presentation to enhance smooth and timely transitions. At the appropriate start time, step 28 initiates operation of the sequence of images to be displayed.

In a preferred embodiment of the invention, image/sound files 29 are, in a preferred embodiment, stored on the same computer which will be displaying the images. This eliminates the need to transfer graphic files over a network. Typically such transfers occur at much slower speeds than occur within the busses of the computer and so tens of thousands of images can be displayed without delays caused by network transfers of files.

Thus, at step 22 computer program 10 has preferably initialized each computer in which computer program is loaded and each computer waits until a respective start time which may be a simultaneous start time, if desired. When the start time arrives as indicated at step 28, then the respective computer plays, displays, and/or sounds the beginning or initial file(s) at step 30 and then continues playing files based on the timing schedule as indicated in the computer loop formed by steps 32, 34, 36, and back to step 30 until the last image/sound is played. After the desired relative or absolute times, which are indicated at 36, these times are utilized to control a sequence of displays/sounds for successive images/sounds 34. This terminates when the last image is determined. Prior to the last image, decision box 32 requires computer control to stay within the loop formed by steps 32, 34, 36, and 30 because the answer to decision box 32 will be NO as indicated. Since all computers are synchronized by the timing function, the overall presentation is presented by a combination of all computers. Where multiple displays are provided on a single computer, then there are preferably multiple instances of computer program 10 running simultaneously and independently. The aforesaid term “multiple instance” refers to instances of copies of computer program 10 being replicated for simultaneous and independent execution as redundant copies in the computer system's random access memory (RAM). The replication of copies of a software program in RAM may be performed by the conventional and well known practice of transferring of the program from a single copy in the computer's magnetic disk memory into different locations in the RAM. In such case scenario, file 18 contains a set of a corresponding multiplicity of timing, image/sound, and other playing or processing) files to operate with the respective copies of the program in RAM. Alternatively, an option could be provided within a single program 10 for specifying multiple displays. However utilizing multiple copies of the same program in RAM to enable their simultaneous and independent execution has been found to be a simpler approach.

If the last image is displayed as indicated at decision box 32, then the answer to decision box 32 takes the YES route whereupon the loop count is incremented as indicated at 38. If the loop count is equal to the specified display loop count as per step 20. Then at decision box 40, program 10 proceeds by the YES route and stops the presentation at step 42. If the incremented loop count is not equal to the display loop count specified at step 20, then the first image is loaded into memory at step 44, the timing is determined and program 10 plays each scenario file as discussed above over as discussed above until the incremented loop count reaches the loop count specified in step 20.

By utilizing program 10 on each respective computer, with the respective image/sound files preferably stored on each respective computer, and preferably with the respective scenario file stored on each computer, then precisely timed displays of images on multiple display monitors connected to one or many like or dislike (because as discussed above program 10 is preferably written in a platform independent language) commonly timed computers is now possible. This new capability allows easy scripting of a variety of different realistic time sequenced display images of, for example, new submarine combat control system displays for concept evaluation, training, and/or other purposes. Differences in image display performance make it difficult or impossible to synchronize the display on dislike systems without use of computer program 10 taught in accord with the present invention. Computer program 10 provides a self-healing timing algorithm that catches up on systems with slower display performance giving the best synchronization possible. Multiple instances of computer program 10 operating on multiple dislike computers execute uniformly and reliably to produce a unique type of presentation by using complex computer systems such as computer complex 100 with up to N computers.

It will be understood that many additional changes in the details, materials, steps and arrangement of parts, which have been herein described and illustrated in order to explain the nature of the invention, may be made by those skilled in the art within the principle and scope of the invention as expressed in the appended claims.

What is claimed is:

1. A method for making a presentation for display on a first plurality of computers forming respective computer stations, utilizing a software control program, said method comprising:
installing said software control computer program on each of said first plurality of computers for the control of at least one unlike presentation display by the respective computer;
installing a corresponding at least one set of files to be played for said presentation on each of said first plurality of computers, each set of files including an initial file to be played and an ending file to be played;
associating playing timing for each set of files of said at least one set of files on each of said plurality of computers such that an effective beginning time and play duration time is associated with each file of the corresponding at least one set of files;
providing a start time for each initial file of said at least one set of files to be played on each of said first plurality of computers;
providing that each computer is synchronized to a common time;
providing that in each instance of controlling an unlike presentation display said control program on each of said first plurality of computers that said control program displays said initial file of each set of the corresponding at least one set of files at said respective start time; and
sequentially playing each file in each set of each corresponding at least one set of files for each of said first plurality of computers.

2. The method of claim 1 further comprising providing selected graphic files for playing within each said corresponding at least one set of files for each of said first plurality of computers.

3. The method of claim 2 further comprising providing selected audio files for playing within at least one of the corresponding at least one set of files.

4. The method of claim 1 wherein at least two of said corresponding at least one set of files comprise different graphic files contained therein.

5. The method of claim 1 further comprising running at least one instance of running a second plurality of simultaneous and independent executions of said software control program on a respective computer of said first plurality of computers such that said respective computer controls a corresponding second plurality of unlike presentation displays and further such that each instance of simultaneous and independent execution of said software control program coordinates a display sequence for a respective one of said corresponding second plurality of unlike presentation displays.

6. The method of claim 1 wherein said effective beginning time and play duration time are determined on the basis of a beginning time and an ending time.

7. The method of claim 1 wherein said effective beginning time and play duration time are determined based on a collective time of previous image files and a given play duration time.

8. A software control program operable for running simultaneously on a plurality of computers to control a presentation utilizing said plurality of computers, each of said computers being associated with at least one unlike presentation display, each of said plurality of computers comprising a local storage wherein said local storage contains a plurality of image files to be displayed during a presentation, at least one scenario file for each of said plurality of computers which comprises timing and sequence information for each of said plurality of image files in said local storage, said software control program comprising:
a read scenario command to read said scenario file;
at least one get image command to retrieve each image file listed in said scenario file; and
a software timing control operable for coordinating timing of display of each image file for each of said plurality of computers.

9. The software control program of claim 8 further comprising said software control program being written in a platform independent computer programming language so as to operable on computers having dislike operating systems.

10. The software control program of claim 9 wherein said platform independent computer programming language is a Java computer programming language.

11. The software control program of claim 8 further comprising a display command to designate a particular presentation display of a set of unlike presentation displays for a desired monitor of a multiple monitor computer.

12. The software control program of claim 11 wherein:
there is associated with each respective monitor of a multiple monitor computer in computer local storage a display raster area which is a part of a composite raster area for all the monitors of the multiple computer monitor; and
said display command designates a particular monitor for said particular presentation display by setting an x, y position within said composite raster area identifying the desired raster area for said presentation display.

13. The software control program of claim 8 further comprising a time control program for setting an internal clock of all of said plurality of computers to a common time.

14. A method for making a presentation for display on a first plurality of computers forming respective computer stations, utilizing a software control program, said method comprising:
installing said software control computer program on each of said first plurality of computers for the control by each computer of at least one unlike presentation display;
simultaneously running each installed software control programs on the respective computer on which installed; and
automatically starting a sequence of displays for each of said first plurality of computers utilizing the respective control program of the simultaneously running control programs installed thereon.

15. The method of claim 14 further comprising providing that said sequences of displays differs among said first plurality of computers.

16. The method of claim 14 further comprising installing a corresponding at least one set of files on each respective one of said first plurality of computers, said corresponding at least one set of files being the basis of the presentation, each set of files of said at least one set of files including an initial file to be played and an ending file to be played.

17. The method of claim 16 further comprising timing playing of each file of each set of files of said corresponding at least one set of files for each respective computer of said first plurality of computers such that a beginning time and play duration time is effectively associated with each file.

18. The method of claim 17 wherein the step of automatically starting further comprises providing a initial file start time for each instance of said software control program on each of said plurality of computers.

19. The method of claim 14 further comprising at least one instance of running a second plurality of simultaneous and independent executions of said software control program on a respective computer of said first plurality of computers such that said respective computer controls a corresponding second plurality of unlike presentation displays and further such that each instance of simultaneous and independent execution of said software control program coordinates a display sequence for a respective one of said corresponding second plurality of unlike presentation displays.

20. The method of claim 14 wherein said first plurality of computers include computers with unlike operating systems, said method further comprising:
providing that said software control program is written in a platform independent programming language.
